(19) United States
(12) Patent Application Publication
(10) Pub. No.: US 2026/0205048 A1
(43) Pub. Date: Jul. 16, 2026

(54) Tools for Spacing and Aligning Solar Panels

(71) Applicant: Ryan Douglas Reid, Newhall, CA (US)

(72) Inventor: Ryan Douglas Reid, Newhall, CA (US)

(21) Appl. No.: 19/022,779

(22) Filed: Jan. 15, 2025

(51) Int. Cl. H02S 20/24; F24S 25/00

(52) U.S. Cl. CPC H02S 20/24; F24S 25/00; F24S 2025/016

(57) ABSTRACT

A tool for spacing and aligning solar panels includes an upper element and a lower element joined to the upper element. The upper element is constructed in a manner such that it is adapted to be readily manipulable (e.g., lifted, moved, rotated, etc.) by a user. The upper element has at least one surface that is substantially flat, allowing the upper element to be placed on, and remain at rest on, the surface of a solar panel. The lower element extends from the upper element at a ninety (90) degree angle from the flat surface of the upper element. The lower element varies in thickness, being thickest at the point where the two elements are joined and narrowest at the tip of the lower element. The tool may include one or more apertures and one or more handles.

### TECHNICAL FIELD

This specification relates generally to the field of methods, systems, and apparatus used for solar panel installation, and more particularly to tools for spacing and aligning solar panels.

### SUMMARY

In accordance with an embodiment, a tool for spacing and aligning solar panels includes an upper element and a lower element joined to the upper element. The upper element is constructed in a manner such that it is adapted to be readily manipulable (e.g., lifted, moved, rotated, etc.) by a user. For example, the upper element may have one or more handles. The upper element has at least one surface that is substantially flat, allowing the upper element to be placed on, and remain at rest on, the surface of a solar panel. The lower element extends from the upper element at a ninety (90) degree angle or approximately a ninety (90) degree angle from the flat surface of the upper element. The lower element varies in thickness, being thickest at or near the point where the two elements are joined and narrowest at the tip of the lower element (the point on the lower element that is farthest from the upper element).

In accordance with an embodiment, a user who is installing solar panels employs the tool in order to create a uniform space between the short ends of two solar panels. The user manipulates the upper element of the tool and moves the upper element in order to insert the lower element of the tool into a space between the short ends of two solar panels. Because the tip of the lower element is the narrowest part of the lower element, the lower element fits easily between the two solar panels. The user then presses down on the tool in order to insert the lower element further into the space between the solar panels until the flat surface of the upper element contacts one of the two solar panels and can rest on the solar panel. When the flat surface of the upper element contacts the solar panel in this manner, the lower element of the tool creates a distance between the two solar panels equal to the greatest thickness of the lower element. The user can perform this process repeatedly in order to ensure that the space between the short ends of the two solar panels is uniform and equal to the greatest thickness of the lower element.

In accordance with another embodiment, a tool for spacing and aligning solar panels includes a first element having a top side and a bottom side. The tool also includes a second element joined to the first element, the second element comprising a first side, a second side, a length axis parallel to the bottom side of the first element, and a thickness defined as a first distance between the first and second sides, wherein the thickness varies as a function of a second distance from the bottom side of the first element. The first side of the second element intersects the bottom side of the first element to form a joint along a second axis parallel to the length axis of the second element. The first side of the second element and the bottom side of the first element form an angle of approximately ninety (90) degrees.

In one embodiment, the first and second sides of the second element are not parallel.

In another embodiment, the first side of the second element and the bottom side of the first element form an angle equal to ninety (90) degrees.

In another embodiment, the first side of the second element and the bottom side of the first element form an angle of greater than ninety (90) degrees.

In another embodiment, the tool, including the first and second elements, comprises a single rigid integrated structure.

In another embodiment, the tool, including the first and second elements, comprises one of injection molded plastic, aluminum or steel.

In another embodiment, the thickness of the second element decreases from three-eighths inch to one-eighth inch.

In another embodiment, the tool further includes a plurality of apertures disposed in at least one of the first element or the second element, wherein each aperture is adapted to provide an opening through which objects located on a first side of the aperture are visible to a viewer located on a second side of the aperture.

In another embodiment, at least one of the first element or the second element comprises a portion comprising a transparent material through which objects located on a first side of the tool are visible to a viewer located on a second side of the tool.

In another embodiment, the tool includes a plurality of handles attached to the first element, each of the plurality of handles adapted to be manipulable by a human hand.

In another embodiment, the tool has a length of thirty (30) inches.

### BRIEF DESCRIPTION OF THE DRAWINGS

FIG. 1 shows a perspective view of a plurality of solar panels being assembled on a flat surface such as a roof;

FIG. 2A shows a first perspective view of a tool for spacing and aligning solar panels in accordance with an embodiment;

FIG. 2B shows a second perspective view of the tool of the embodiment of FIG. 2A;

FIG. 2C shows a cross-sectional view of the tool of the embodiment of FIG. 2A;

FIG. 2D shows a third perspective view of the tool of the embodiment of FIG. 2A;

FIG. 2E shows a cross-sectional view of a tool for spacing and aligning solar panels in accordance with another embodiment;

FIG. 2F shows a cross-sectional view of a tool for spacing and aligning solar panels in accordance with another embodiment;

FIG. 3A shows a perspective view of a tool for spacing and aligning solar panels in accordance with another embodiment;

FIG. 3B shows a cross-sectional view of the tool of the embodiment of FIG. 3A;

FIG. 4A shows a perspective view of a tool for spacing and aligning solar panels in accordance with another embodiment; and

FIG. 4B shows a cross-sectional view of the tool of the embodiment of FIG. 4A.

These and other advantages of the present disclosure will be apparent to those of ordinary skill in the art by reference to the following Detailed Description and the accompanying drawings.

### DETAILED DESCRIPTION

In accordance with an embodiment, a tool for spacing and aligning solar panels includes an upper element and a lower element joined to the upper element. The upper element is constructed in a manner such that it is adapted to be readily manipulable (e.g., lifted, moved, rotated, etc.) by a user. For example, the upper element may have one or more handles. The upper element has at least one surface that is substantially flat, allowing the upper element to be placed on, and remain at rest on, the surface of a solar panel. The lower element extends from the upper element, at a ninety (90) degree angle or approximately a ninety (90) degree angle from the flat surface of the upper element. The lower element varies in thickness, being thickest at or near the point where the two elements are joined and narrowest at the tip of the lower element (the point on the lower element that is farthest from the upper element).

In accordance with an embodiment, a user who is installing solar panels employs the tool in order to create a uniform space between the short ends of two solar panels. The user manipulates the upper element of the tool and moves the upper element in order to insert the lower element of the tool into a space between the short ends of two solar panels. Because the tip of the lower element is the narrowest part of the lower element, the lower element fits easily between the two solar panels. The user then presses down on the tool in order to insert the lower element further into the space between the solar panels until the flat surface of the upper element contacts one of the two solar panels and can rest on the solar panel. When the flat surface of the upper element contacts the solar panel in this manner, the lower element of the tool creates a distance between the two solar panels equal to the greatest thickness of the lower element. The user can perform this process repeatedly in order to ensure that the space between the short ends of the two solar panels is uniform and equal to the greatest thickness of the lower element.

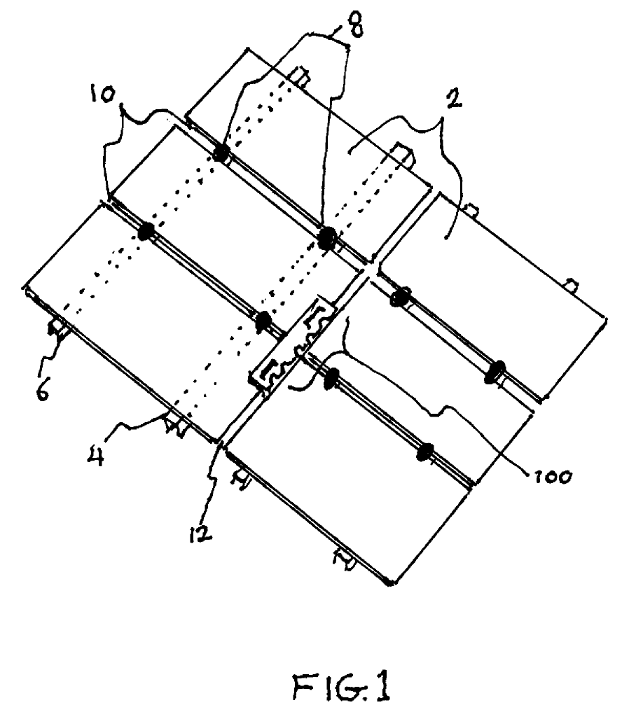

FIG. 1 shows a perspective view of a plurality of solar panels 2 being assembled on a flat surface such as a roof. Each panel 2 is supported by two support rails 4, 6. Ideally, the long sides of the panels are separated by spaces 10 that maintain a uniform distance between the panels of approximately three-eighths of an inch, which allows for expansion and contraction of the panels due to temperature changes and helps dirt, debris and water to be removed from the surface of the panels 2. In many existing systems, spacers 8 are screwed into the rails 4, 6 to hold down the panels 2 on their long sides and in order to maintain the width of space 10 at approximately three eighths of an inch. Spacers 8 are typically provided by the manufacturer of the solar panel system.

However, manufacturers of solar panel systems do not typically provide spacers for use in adjusting and maintaining a distance 12 between the short sides of each panel 2. No spacer tool is available to assist installers in creating a uniform distance needed between the short sides of the solar panels to accommodate expansion and contraction due to temperature changes. Accordingly, there is a need for a tool that can be used to adjust and maintain the space between the short sides of solar panels.

A tool for spacing and aligning solar panels is disclosed herein. The tool may be used to ensure that the distance between the short sides of adjacent panels is adequate and uniform and to help ensure that panels are evenly aligned.

In accordance with an embodiment, a tool includes two elements each having a longer side and a shorter side. The two elements are rigidly joined along their lengths to form an angle equal to approximately ninety (90) degrees. Among the two elements, a first element has a length of approximately thirty (30) inches and a width of approximately four (4) inches, and has a uniform thickness of approximately one-eight (1/8) inch. The second element has a length of approximately thirty (30) inches and a width of approximately two (2) inches. The second element has a thickness that varies as a function of distance from the joint between the elements, with the greatest thickness at a point closest to the joint and the smallest thickness at the tip of the second element most distant from the joint. In one embodiment, the thickness of the second element is approximately three-eighths (3/8) inch at a point proximate the joint and decreases uniformly to one-eight (1/8) inch at the tip of the second section.

In various embodiments, among the two elements, the first element has a length between fifteen (15) and forty (40) inches, preferably thirty (30) inches, and a width between two (2) and six (6) inches, preferably four (4) inches, and a thickness between one-tenth (1/10) inch and one-half (1/2) inch, preferably one-eighth (1/8) inch. The second element has a length between fifteen (15) and forty (40) inches, preferably thirty (30) inches, and a width between one (1) and three (3) inches, preferably two inches (2) inches.

In accordance with another embodiment, a tool for spacing and aligning solar panels includes a first element having a top side, a bottom side, a first length axis, a first width axis perpendicular to the first length axis, and a first thickness. The tool also includes a second element joined to the first element, the second element comprising a first side, a second side, a second length axis, a second width axis perpendicular to the bottom side of the first element, and a second thickness defined as a first distance between the first and second sides, wherein the second thickness varies as a function of a second distance from the bottom side of the first element. The first side of the second element intersects the bottom side of the first element to form a joint along a second axis parallel to the second length axis. The first side of the second element and the bottom side of the first element form an angle of substantially ninety (90) degrees.

In one embodiment, the tool, including the first and second elements, comprises a single rigid integrated structure.

In another embodiment, the tool, including the first and second elements, comprises one of injection molded plastic, aluminum or steel.

In another embodiment, the first and second elements are joined forming a joint. The second thickness of the second element decreases from three-eighths inch at a point proximate the joint to one-eighth inch at a tip of the second element most distant from the joint.

In another embodiment, the tool includes a plurality of apertures disposed in at least one of the first element or the second element, wherein each aperture is adapted to provide an opening through which objects located on a first side of the aperture are visible to a viewer located on a second side of the aperture. In another embodiment, at least one of the first or second elements includes a transparent or translucent material through which objects located on a first side of the material are visible to a viewer located on a second side of the material.

In another embodiment, the tool further includes a plurality of handles attached to the first element, each of the plurality of handles adapted to be manipulable by a human hand.

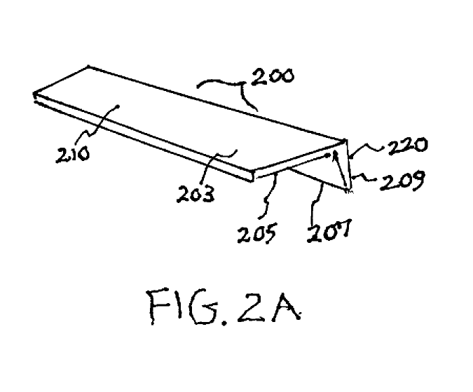

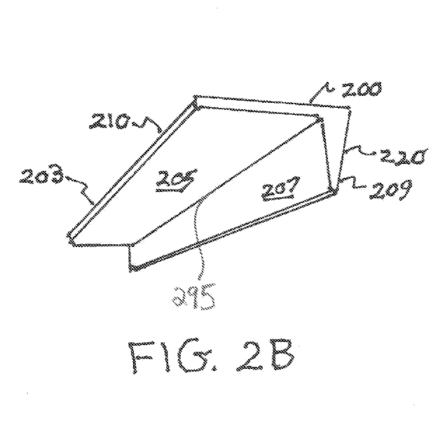

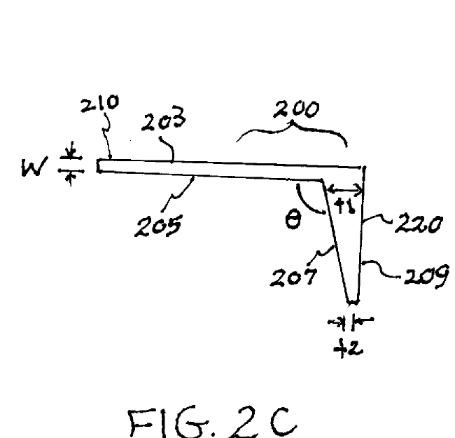

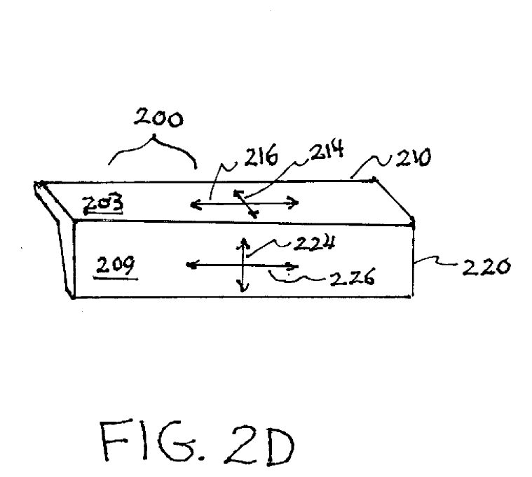

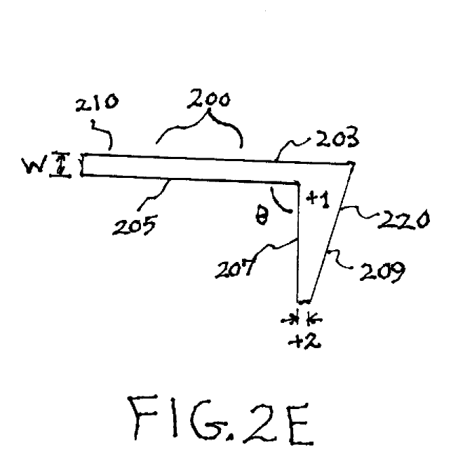

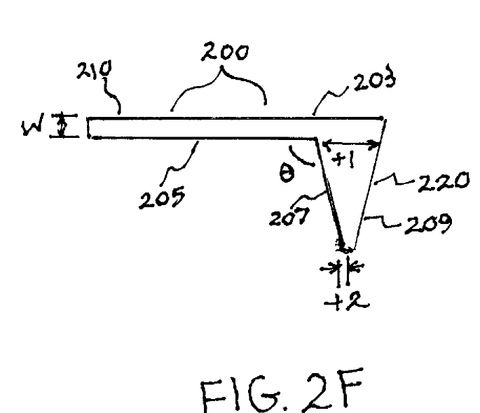

FIGS. 2A shows a first perspective view of a tool for spacing and aligning solar panels in accordance with an embodiment. Tool 200 includes a first element 210 and a second element 220 joined to the first element. First element 210 has a top side 203 and a bottom side 205. Second element 220 has a first side 207 and a second side 209.

FIG. 2B shows a second perspective view of the tool of the embodiment of FIG. 2A. First element 210 and second element 220 are joined forming a joint 295. In the illustrative embodiment, joint 295 is parallel to the length axis of first element 210 and the length axis of second element 220. In other embodiments, joint 295 is parallel to the length axis of second element 220 but is not parallel to the length axis of first element 210.

FIG. 2C shows a cross-section of tool 200 in accordance with an embodiment. First element 210 has a first thickness W. In the illustrative embodiment of FIG. 2C, thickness W of first element 210 is substantially uniform. In other embodiments, first thickness W of first element 210 may vary.

Second element 220 has a second thickness which varies from a greatest thickness t1 at a point at or near the joint 295 between the first and second elements to a smallest thickness t2 at the tip of the second element farthest from the joint. In the illustrative embodiment, the first side 207 and second side 209 of second element 220 are not parallel. In one embodiment, the second thickness of second element 220 may be measured as the distance between first side 207 and second side 209 in a plane parallel to bottom side 205 of first element and in a direction perpendicular to the length axis of second element 220.

In the illustrative embodiment of FIG. 2C, an intersection of bottom side 205 of first element 210 and first side 207 of second element 220 forms an angle θ of greater than ninety degrees. For example, bottom side 205 of first element 210 and first side 207 of second element 220 form an angle selected from a range of angles comprising angles greater than ninety (90) degrees and less than or equal to ninety-five (95) degrees. The intersection of top side 203 of first element 210 and second side 209 of second element forms an angle of ninety (90) degrees.

FIG. 2D shows a perspective view of tool 200 in accordance with an embodiment. First element 210 has a width axis 214 and a length axis 216. Second element 220 has a width axis 224 and a length axis 226.

FIG. 2E shows a cross-sectional view of tool 200 in accordance with another embodiment. Bottom side 205 of first element 210 and first side 207 of second element 220 form an angle θ equal to ninety (90) degrees. The intersection of top side 203 of first element 210 and second side 209 of second element 220 forms an angle of less than ninety (90) degrees.

FIG. 2F shows a cross-sectional view of tool 200 in accordance with another embodiment. The intersection of bottom side 205 of first element 210 and first side 207 of second element 220 forms an angle θ of greater than ninety (90) degrees. The intersection of top side 203 of first element 210 and second side 209 of second element 220 forms an angle of less than ninety (90) degrees.

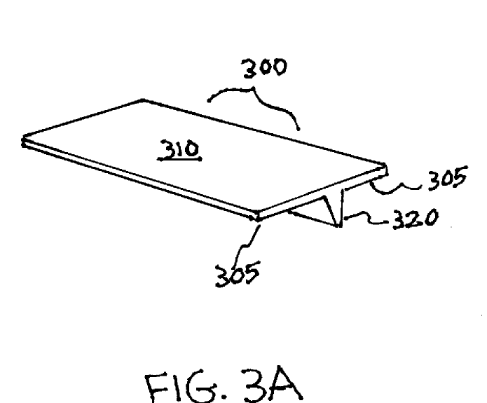

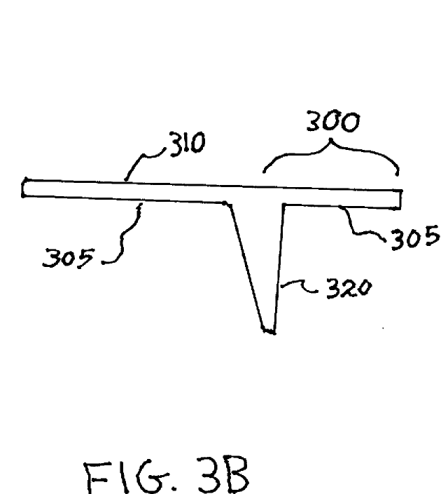

FIG. 3A shows a tool for spacing and aligning solar panels in accordance with another embodiment. Tool 300 includes a first element 310 and a second element 320. Second element 320 is joined to first element 310 forming a joint parallel to the length axis of second element 320. Second element 320 has a thickness that varies as a function of distance from the joint. In this embodiment, a first portion of the bottom side 305 of first element 310 extends on a first side of second element 320, and a second portion of bottom side 305 of first element 310 extends on a second side of second element 320.

FIG. 3B shows a cross-sectional view of the tool of the embodiment of FIG. 3A.

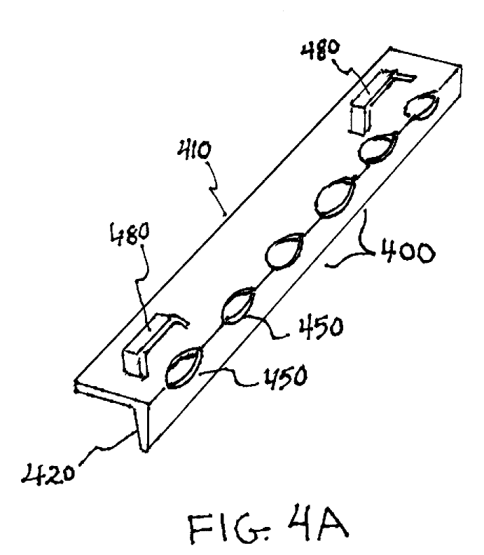

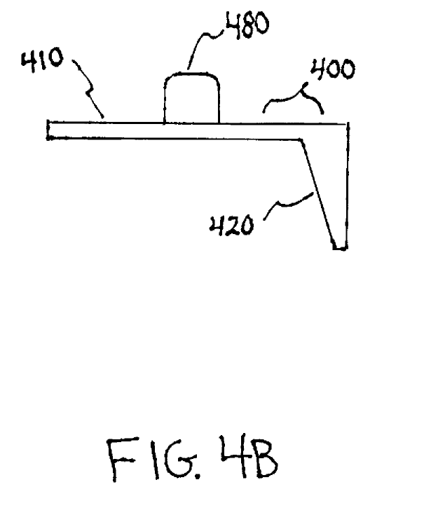

FIG. 4A shows a tool for spacing and aligning solar panels in accordance with another embodiment. Tool 400 includes a first element 410 and a second element 420 that are joined forming a joint parallel to the length axes of the two elements. Tool 400 also includes a plurality of apertures 450 adapted to provide a “see-through” feature. More particularly, each aperture is adapted to provide an opening through which objects located on a first side of the aperture are visible to a viewer located on a second side of the aperture. Thus, a user employing tool 400 may place the tool along the edge of a first solar panel such that the second element 420 extends into the space between the first solar panel and a second solar panel. Portions of the first solar panel are then visible to the user through apertures 450, allowing the user to ensure that the positioning and spacing of the solar panels is as desired.

In the illustrative embodiment of FIG. 4A, a first portion of each aperture 450 is formed in first element 410 and a second portion of each aperture 450 is formed in second element 410. In another embodiment, an aperture may be formed entirely in first element 410. In another embodiment, an aperture may be formed entirely in first element 410.

In another embodiment, a similar “see-through” feature is provided by constructing a tool for spacing and aligning solar panels partly or entirely of transparent or translucent material. More specifically, a tool for spacing and aligning solar panels includes a first element and a second element constructed similarly to tool 200 of FIGS. 2A-2D, for example. At least one portion of the first element, or at least one portion of the second element includes a transparent or translucent material through which objects located on a first side of the element are visible to a viewer located on a second side of the element. For example, the first element may include a transparent portion through which a user is able to see a portion of a solar panel on the other side of the first element.

Referring again to the embodiment of FIG. 4A, tool 400 includes a plurality of handles 480. Handles 480 are adapted to be manipulable by a human hand. Thus, handles 480 enable a user to lift, move, and place the tool 400 more easily. In other embodiments, a tool may include only a single handle or may include more than two handles. In the illustrative embodiment, handles 480 are disposed on the top side of first element 410. In other embodiments, one or more handles may be placed at other locations on the tool.

FIG. 4B shows a cross section of the tool of the embodiment of FIG. 4A.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A tool for spacing and aligning solar panels, the tool comprising:
a first element having a top side and a bottom side; and
a second element joined to the first element, the second element comprising a first side, a second side, a length axis parallel to the bottom side of the first element, and a thickness defined as a first distance between the first and second sides, wherein the thickness varies as a function of a second distance from the bottom side of the first element;
wherein the first side of the second element intersects the bottom side of the first element to form a joint along a second axis parallel to the length axis of the second element;
wherein the first side of the second element and the bottom side of the first element form an angle of substantially ninety (90) degrees.

2. The tool for spacing and aligning solar panels of claim 1, wherein the first and second sides of the second element are not parallel.

3. The tool for spacing and aligning solar panels of claim 1, wherein the first side of the second element and the bottom side of the first element form an angle equal to ninety (90) degrees.

4. The tool for spacing and aligning solar panels of claim 1, wherein the first side of the second element and the bottom side of the first element form an angle of greater than ninety (90) degrees.

5. The tool for spacing and aligning solar panels of claim 1, wherein the tool, including the first and second elements, comprises a single rigid integrated structure.

6. The tool for spacing and aligning solar panels of claim 1, wherein the tool, including the first and second elements, comprises one of injection molded plastic, aluminum or steel.

7. The tool for spacing and aligning solar panels of claim 1, wherein the thickness of the second element decreases from three-eighths inch to one-eighth inch.

8. The tool for spacing and aligning solar panels of claim 1, further comprising a plurality of apertures disposed in at least one of the first element or the second element, wherein each aperture is adapted to provide an opening through which objects located on a first side of the aperture are visible to a viewer located on a second side of the aperture.

9. The tool for spacing and aligning solar panels of claim 1, at least one of the first element or the second element comprises a portion comprising a transparent material through which objects located on a first side of the tool are visible to a viewer located on a second side of the tool.

10. The tool for spacing and aligning solar panels of claim 1, further comprising a plurality of handles attached to the first element, each of the plurality of handles adapted to be manipulable by a human hand.

11. The tool for spacing and aligning solar panels of claim 1, wherein the tool has a length of thirty (30) inches.

12. A method comprising:
creating a desired space between first and second solar panels by repeatedly performing a set of operations, the set of operation comprising:
placing a tool comprising a first element and a second element joined to the first element, the first element having at least one substantially flat surface, the second element having a thickness varying from a greatest thickness at a point proximate the at least one substantially flat surface of the first element to a smallest thickness at a tip of the second element, in a position such that the tip of the second element is between first and second solar panels; and
manipulating the first element of the tool in a manner to cause the second element to be inserted between the first and second solar panels until the at least one substantially flat surface contacts the first solar panel.
